(19) United States
(12) Patent Application Publication
(10) Pub. No.: US 2008/0065451 A1
(43) Pub. Date: Mar. 13, 2008

(54) SYSTEM AND METHOD FOR CONVERTING ELECTRONIC ORDERS TO WORK ORDERS

(75) Inventors: Wai-Sing-Winslow For, Shenzhen (CN); Kuang-Yuan Chang, Tu-Cheng (TW); Yi-Hung Wang, Tu-Cheng (TW); Bao Li, Shenzhen (CN); Xue-Jun Xia, Shenzhen (CN); Gang Huang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/616,876

(22) Filed: Dec. 28, 2006

(30) Foreign Application Priority Data
Sep. 8, 2006 (CN) 200610062514.5

(51) Int. Cl. G05B 19/418

(52) U.S. Cl. 705/8

(57) ABSTRACT

A system for converting electronic orders to work orders includes a shop floor control (SFC) system (2000) and an enterprise resource planning (ERP) system (3000). The SFC system includes a receiving module (2100), a primary work order creation module (2200), an uploading module (2300), and a production work order generation module (2400). The receiving module receives electronic orders. The primary work order creation module creates primary work orders according to the electronic orders. The uploading module uploads information of the primary work orders to the ERP system. The ERP system creates check orders according to the uploaded information of the primary work orders, and updates the check orders. The production work order generation module downloads information of the check orders, and generates production work orders according to the downloaded information of the check orders. A method for converting electronic orders to work orders is also provided.

### BACKGROUND OF THE INVENTION

1. Field of the Invention

The invention relates to systems and methods for processing production information, and particularly to a system and method for converting electronic orders to work orders.

2. Description of Related Art

With the development of the Internet, a new electronic business trade mode—electronic data interchange (EDI) is developed. EDI is the computer-to-computer exchange of business data in standard formats. In EDI, information is organized according to a specified format set by both parties, allowing a “hands off” computer transaction that requires no human intervention or relying on either end. The information contained in an EDI transaction set is, for the most part, the same as on a conventionally printed document.

However, EDI often has a high initial price tag and maintenance costs, transmission data through EDI is difficult to parse, so it is difficult for medium to small scaled enterprises to trade with other enterprises via EDI. Then, a business-to-business communication standard—RosettaNet is developed. The RosettaNet-7B5 standard of the RosettaNet can be used to transmit electronic orders between enterprises.

However, to convert 7B5 files to work orders is difficult for conventional manufacturers when the conventional manufacturers receive electronic orders via RosettaNet-7B5.

### SUMMARY OF THE INVENTION

An exemplary embodiment of the present invention provides a system for converting electronic orders to work orders. The system includes a shop floor control (SFC) system and an enterprise resource planning (ERP) system. The SFC system includes a receiving module, a primary work order creation module, an uploading module, and a production work order generation module. The receiving module receives electronic orders. The primary work order creation module creates primary work orders according to the electronic orders. The uploading module uploads information of the primary work orders to the ERP system. The ERP system creates check orders according to the uploaded information of the primary work orders, and updates the check orders. The production work order generation module downloads information of the check orders, and generates production work orders according to the downloaded information of the check orders. A method for converting electronic orders to work orders is also provided.

Another exemplary embodiment of the present invention provides a method for converting electronic orders to work orders. The method includes: receiving electronic orders; creating primary work orders according to the electronic orders; uploading information of the primary work orders to an enterprise resource planning (ERP) system; creating check orders according to the uploaded information of the primary work orders, and updating the check orders by the ERP system; and downloading information of the check orders from the ERP system, and generating production work orders according to the downloaded information of the check orders.

Other advantages and novel features will become more apparent from the following detailed description when taken in conjunction with the accompanying drawings, in which:

### BRIEF DESCRIPTION OF THE DRAWINGS

FIG. 1 is a schematic diagram of functional modules of a system for converting electronic orders to work orders of an exemplary embodiment;

FIG. 2 is a schematic diagram of detailed functional modules of a primary work order creation module of FIG. 1;

FIG. 3 is a schematic diagram of detailed functional modules of an uploading module of FIG. 1;

FIG. 4 is a schematic diagram of detailed functional modules of an enterprise resource planning (ERP) system of FIG. 1;

FIG. 5 is a schematic diagram of detailed functional modules of a production work order generation module of FIG. 1;

FIG. 6 is a flowchart of a method for converting electronic orders to work orders of another exemplary embodiment;

FIG. 7 is a detailed flowchart of part of the method for converting electronic orders to work orders of FIG. 6;

FIG. 8 is a detailed flowchart after a node A of FIG. 7;

FIG. 9 is a detailed flowchart after a node B of FIG. 7; and

FIG. 10 is a detailed flowchart after a node C of FIG. 8.

### DETAILED DESCRIPTION OF THE INVENTION

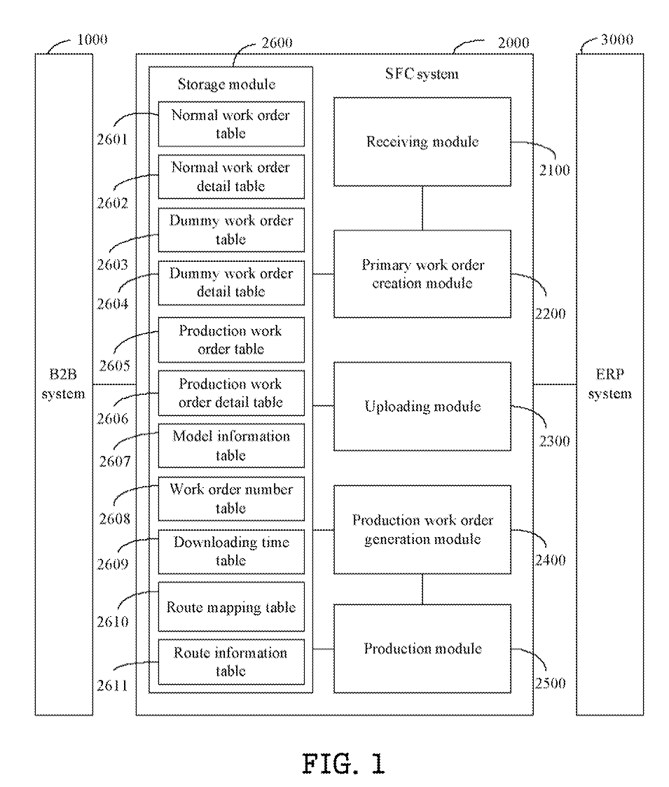

FIG. 1 is a schematic diagram of functional modules of a system for converting electronic orders to work orders of an exemplary embodiment. In the exemplary embodiment, the system includes a business-to-business (B2B) system 1000, a shop floor control (SFC) system 2000, and an enterprise resource planning (ERP) system 3000. The ERP system 3000 may be a SAP system. In other embodiments, the ERP system 300 may be other types of ERP systems.

The B2B system 1000 transmits electronic orders to the SFC system 2000. In the exemplary embodiment, the electronic orders are RosettaNet-7B5 files. The SFC system 2000 receives the electronic orders, and creates primary work orders according to the electronic orders, and also uploads information of the primary work orders to the ERP system 3000. Then the ERP system 3000 creates check orders according to the uploaded information of the primary work orders, and updates the check orders. Afterwards, the SFC system 2000 downloads information of the check orders from the ERP system 3000, and generates production work orders according to the downloaded information of the check orders. Therefore, the system for converting electronic orders to work orders successfully converts the electronic orders to the production work orders via the SFC system 2000 and the ERP system 3000. In this embodiment, the system converts the RosettaNet-7B5 files to the production work orders.

The SFC system 2000 includes a receiving module 2100, a primary work order creation module 2200, an uploading module 2300, a production work order generation module 2400, a production module 2500, and a storage module 2600.

The storage module 2600 stores various tables, such as a normal work order table 2601, a normal work order detail table 2602, a dummy work order table 2603, a dummy work order detail table 2604, a production work order table 2605, a production work order detail table 2606, a model information table 2607, a work order number table 2608, a downloading time table 2609, a route mapping table 2610, and a route information table 2611.

The model information table 2607 includes model information from the ERP system 3000.

The work order number table 2608 includes information of normal work order numbers and dummy work order numbers. In the exemplary embodiment, the work order number table 2608 includes a name field, a flow number field, and a prefix field.

The name field is for indicating whether each work number is a normal work order number or a dummy work order number, and indicating a business unit (BU) of each work order number. In the exemplary embodiment, units responsible for different types of products are divided into different BUs. The BUs include a multi-service customer edge business unit (MCEBU), a desktop switch business unit (DSBU), a public communication business unit (PCBU), an Internet protocol business unit (IPCBU), and a wireless network business unit (WNBU). For example, one name field may be “normal-PCBU”.

In other embodiments, manufactures using the present invention may divide units responsible for different types of products into other BUs according to different requirements.

In the exemplary embodiment, each work order number includes a prefix and a flow number. The prefix indicates whether the work order number is a normal work order number (8) or a dummy work order number (D), and the BU name of the work order number. Such as, prefixes 8M/D/P/I/W respectively indicate normal work numbers of MCEBU, DSBU, PCBU, IPCBU, or WNBU. Prefixes DM/D/P/I/W respectively indicate dummy work numbers of MCEBU, DSBU, PCBU, IPCBU, or WNBU. The flow number includes 10 digits, and an initial flow number is “0000000001”.

For example, a work order number “8P0000000002”, would indicate the work order number is a normal work order number, and the BU of the work order number is PCBU. It should be noted that the flow number of the present invention is not restricted to the above example.

The flow number field and the prefix field of the work order number table 2608 are respectively for storing the flow number information and the prefix information of each work order number.

The normal work order table 2601 includes information of normal work orders. In the exemplary embodiment, the normal work orders are created according to the electronic orders. The normal work order table 2601 includes a work order number field, a sale order number field, a line number field, a ship set field, a model field, an order type field, a return message field, an extensible markup language (XML) file name field, a to country field, and a factory completed date field.

In other embodiments, the normal work order table 2601 may include more or less fields according to different requirements.

In the exemplary embodiment, the electronic orders includes sale order number information, line number information, and ship set information. The sale order number field, the line number field, and the ship set field of the normal work order table 2601 respectively store the sale order number information, the line number information, and the ship set information from the electronic orders.

The work order number field indicates work order numbers of the normal work orders. In the exemplary embodiment, the SFC system 2000 generates the work order numbers according to the sale order number information, the line number information, and the ship set information of the electronic orders, and the work order number information table 2608.

The order type field indicates order types. In the exemplary embodiment, the order types include a system order type and a spare order type. The system order type indicates assembled machines required by customers. The spare order type indicates fittings of the machines required by customers, such as power lines and cables.

The return message field indicates messages from the ERP 3000. In the exemplary embodiment, when the SFC system 2000 uploads the information of the primary work orders to the ERP system 3000, the ERP system 3000 returns messages to the SFC system 2000. The messages may be acknowledge messages, which indicate that the information of the primary work orders is successfully uploaded to the ERP system 3000. The messages may also be error messages, which indicate that the information of the primary work orders is unsuccessfully uploaded to the ERP system 3000. The messages from the ERP system 3000 are then recorded in the return message field of the normal work order table 2601.

The XML file name field indicates names of the electronic orders, such as names of 7B5 files.

The to country field indicates which country products of each work order are delivered to.

The normal work order detail table 2602 includes detailed information of the normal work orders. In the exemplary embodiment, the detailed information includes option part numbers and request quantity of each option part. Accordingly, the normal work order detail table 2602 includes a work order number field, an option part number field, and a request quantity field.

In other embodiments, the detailed information of the normal work orders may include more or less information, and accordingly the normal work order detail table 2602 may include more or less fields.

The dummy work order table 2603 includes information of dummy work orders. In the exemplary embodiment, the dummy work orders are created according to the electronic orders. The fields included in the dummy work order table 2603 are the same as those included in the normal work order table 2601.

The dummy work order detail table 2604 includes detailed information of the dummy work orders. In the exemplary embodiment, the fields included in the dummy work order detail table 2604 are the same as those included in the normal work order detail table 2602.

The downloading time table 2609 indicates when the SFC system 2000 downloads information of the production work orders from the ERP system 3000. In the exemplary embodiment, the downloading time table 2609 includes a type name field and a time spot field. The type name field indicates downloaded model types.

The time spot field indicates a latest time spot for downloading work orders. For example, one time spot may be “2006-04-12 15:19:19”.

The route mapping table 2610 is for linking route identifiers in the ERP system 3000 and the route identifiers in the SFC system 2000. When one route identifier in the ERP system 3000 is known, the corresponding route identifier in the SFC system 2000 is known via the route mapping table 2610.

The route information table 2611 is for recording actual routes corresponding to each route identifier in the SFC system 2000. In the exemplary embodiment, the actual routes include a plurality of assembly workstations.

The production work order 2605 includes information of production work orders. In the exemplary embodiment, the production table 2605 includes a wok order number field, a model field, a route identifier field, and a start identifier field.

The work order number field indicates work order numbers of the production work orders. The model field indicates model information of the production work orders. The start identifier field indicates whether each production work order has been employed for production. For example, the start identifier field may be set to 1, indicating the production work order has been employed for production.

The production work order detail table 2606 includes detailed information of the production work orders. In the exemplary embodiment, the production work order table 2606 includes a work order number field, an option part number field, and a request quantity field.

The receiving module 2100 receives electronic orders from the B2B system 1000. In the exemplary embodiment, the electronic orders are RosettaNet-7B5 files. The receiving module 2100 receives the electronic orders, and then puts the electronic orders in an un-accessed file directory.

The primary work order creation module 2200 creates primary work orders according to the electronic orders. In the exemplary embodiment, the primary work orders include normal work orders and dummy work orders. The primary work order creation module 2200 also records information of the normal work orders in the normal work order table 2601 and the normal work order detail table 2602, and records information of the dummy work orders in the dummy work order table 2603 and the dummy work order detail table 2604.

The uploading module 2300 uploads information of the primary work orders to the ERP system 3000. In the exemplary embodiment, the uploading module 2300 selects some primary work orders, and then uploads information of the selected primary work orders to the ERP system 3000. If the selected primary work orders are normal work orders, the uploading module 2300 directly uploads the information of the selected primary work orders to the ERP system 3000. If the selected primary work orders are dummy work orders, the uploading module 2300 converts the dummy work orders to normal work orders, and then uploads information of the converted normal work orders to the ERP system 3000.

The ERP system 3000 receives the uploaded information of the primary work orders, and creates check orders according to uploaded the information of the primary work orders, and also updates the check orders. In the exemplary embodiment, content of the check orders is the same as that of the primary work orders.

The production work order generation module 2400 downloads information of the check orders from the ERP 3000, and generates production work orders according to the downloaded information of the check orders. The production work order generation module 2400 also records information of the production work orders in the production work order table 2605 and the production work order detail table 2606.

The production module 2500 employs the production work orders for production. In the exemplary embodiment, the production module 2500 selects un-started production work orders according to the start identifier field of the production work order table 2605, and then generates dummy numbers according to BUs, dates, and flow numbers, and then employs the selected production work orders for production.

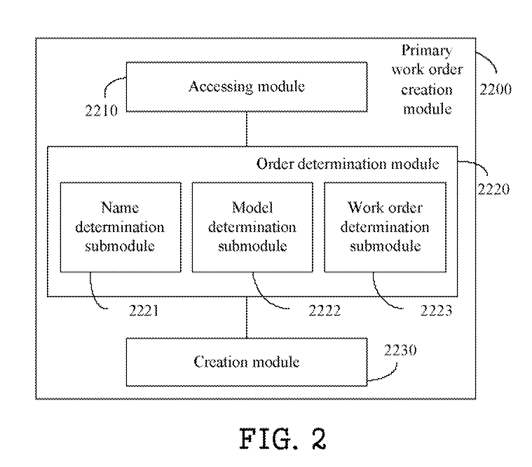

FIG. 2 is a schematic diagram of detailed functional modules of the primary work order creation module 2200 of FIG. 1. In the exemplary embodiment, the primary work order creation module 2200 includes an accessing module 2210, an order determination module 2220, and a creation module 2230.

The accessing module 2210 accesses the electronic orders received by the receiving module 2100. In the exemplary embodiment, the accessing module 2210 accesses the RosettaNet-7B5 files from the un-accessed file directory.

The order determination module 2220 identifies the electronic orders accessed by the accessing module 2210. The creation module 2230 creates the primary work orders according to the identified result of the order determination module 2220.

In the exemplary embodiment, the order determination module 2220 includes a name determination submodule 2221, a model determination submodule 2222, and a work order determination module 2223.

The name determination module 2221 determines whether electronic orders have been accessed. In the exemplary embodiment, the name determination submodule 2221 determines whether the electronic orders have been accessed according to whether names of the electronic orders exist in the XML file name field of the normal work order table 2601. If the names of the electronic order exist in the XML file name of the normal work order table 2601, the name determination submodule 2221 determines that the electronic orders have been accessed. If the names of the electronic order do not exist in the XML file name of the normal work order table 2601, the name determination submodule 2221 determines that the electronic orders have not been accessed.

If the electronic orders have been accessed, the name determination submodule 2221 moves the electronic orders to a re-transmission file directory. If the electronic orders have not been accessed, the model determination submodule 2222 determines whether models included in the electronic orders exist in the model information table 2607.

If the models included in the electronic orders do not exist in the model information table 2607, the model determination submodule 2222 generates an alarm. If the models included in the electronic orders exist in the model information table 2607, the work order determination submodule 2223 determines whether work orders defined by the electronic orders exist in the normal work order table 2601. In the exemplary embodiment, the work order determination submodule 2223 determines whether work orders defined by the electronic order exist in the normal work order table 2601 according to whether sale order number information, line number information, and ship set information of each work order defined by the electronic orders respectively exist in the sale order number field, the line number field, and the ship set field of an entry of the normal work order table 2601.

If the sale order number information, the line number information, and the ship set information of each work order defined by the electronic orders do not respectively exist in the sale order number field, the line number field, and the ship set field of one entry of the normal work order table 2601, the work order determination submodule 2223 determines that the work orders defined by the electronic orders do not exist in the normal work order table 2601. If the sale order number information, the line number information, and the ship set information of each work order defined by the electronic orders respectively exist in the sale order number field, the line number field, and the ship set field of one entry of the normal work order table 2601, the work order determination submodule 2223 determines that the work orders defined by the electronic orders exist in the normal work order table 2601. In the following text, the work orders with the sale order, the line number, and the ship set information the same as that of the electronic orders are called original work orders.

If the work orders defined by the electronic orders do not exist in the normal work order table 2601, the work order determination submodule 2230 creates normal work orders, and records information of the normal work orders in the normal work order table 2601 and the normal work order detail table 2602. Then the creation module 2230 moves the electronic orders to an accessed file directory.

If the work orders defined by the electronic orders exist in the normal work order table 2601, the work order determination submodule 2223 further determines whether information of the original work orders has been uploaded to the ERP system 3000. In the exemplary embodiment, if the information of the original work order has not been uploaded to the ERP system 3000, the creation module 2230 updates the information of the original work orders in the normal work order table 2601 and the normal work order detail table 2602 according to the electronic orders. If the information of the original work orders has been uploaded to the ERP system 3000, the creation module 2230 creates dummy work orders, and records information of the dummy work orders in the dummy work order table 2603 and the dummy work order detail table 2604. Then the creation module 2230 moves the electronic orders to the accessed file directory.

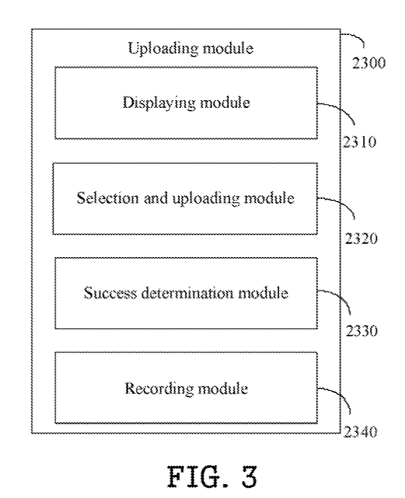

FIG. 3 is a schematic diagram of detailed functional modules of the uploading module 2300 of FIG. 1. In the exemplary embodiment, the uploading module 2300 includes a displaying module 2310, a selection and uploading module 2320, a success determination module 2330, and a recording module 2340.

The displaying module 2310 displays primary work orders that are not uploaded to the ERP system 3000. The primary work orders include normal work orders and dummy work orders. The selection and uploading module 2320 selects primary work orders required to be produced, and uploads information of the selected primary work orders to the ERP system 3000. In the exemplary embodiment, the selection and uploading module 2320 may automatically select the primary work orders required to be produced, according to a list provided by customers, or select the primary work orders required to be produced, according to information input by operators or engineers.

When the selected primary work orders are normal work orders, the selection and uploading module 2320 directly uploads information of the primary work orders to the ERP system 3000. When the selected primary work orders are dummy work orders, the selection and uploading module 2320 converts the selected dummy work orders to normal work orders, and then records information of the converted normal work orders in the normal work order table 2601 and the normal work order detail table 2602. In the exemplary embodiment, the difference between the dummy work orders and the converted normal work orders is in that the work order numbers of the dummy work orders and the work order numbers of the converted normal work orders are respectively dummy work order numbers and normal work order numbers. The other information of the dummy work orders is the same that of the converted normal work orders. Then the selection and uploading module 2320 uploads the information of the converted normal work orders to the ERP system 3000.

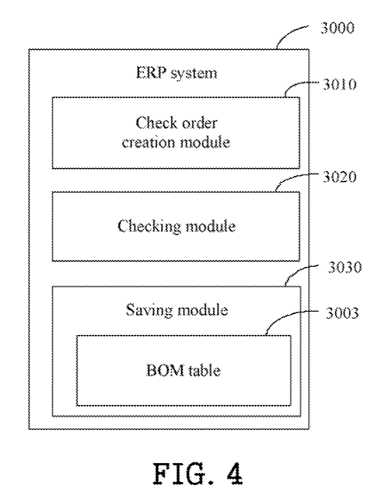

FIG. 4 is a schematic diagram of detailed functional modules of the ERP system 3000 of FIG. 1. In the exemplary embodiment, the ERP system 3000 includes a check order creation module 3010, a checking module 3020, and a saving module 3030. The saving module 3030 stores a bill of material (BOM) table 3003. The BOM table 3003 includes a list of materials of each model.

The check order creation module 3010 creates the check orders according to the uploaded information of the primary work orders. The check orders may be saved in the saving module 3030. The checking module 3020 checks and updates the check orders according to the BOM table 3003. In the exemplary embodiment, the checking module 3020 checks whether part numbers in each check order are listed in the BOM table 3003. If the part numbers in the check orders are listed in the BOM table 3003, the checking module 3020 transmits acknowledge messages to the SFC system 2000. If the part numbers in the check orders are not listed in the BOM table 3003, the checking module 3020 transmits error messages to the SFC system 2000. The checking module 3020 also supplements necessary information, such as necessary part numbers, for the check orders. Thus, the checking module 3020 successfully updates the check orders.

Referring to FIG. 3 again, the success determination module 2330 of the uploading module 2300 determines whether acknowledge messages are received from the ERP system 3000. If the acknowledge messages are received from the ERP system 3000, the uploading module 2300 determines that the information of the primary work orders is successfully uploaded to the ERP system 3000. In such case, the recording module 2340 records the acknowledge messages in the return message field of the normal work order table 2601.

If the acknowledge messages are not received from the ERP system 3000, the uploading module 2300 determines that the information of the primary work orders is unsuccessfully uploaded to the ERP system 3000. In such case, the recording module 2340 amends the error messages of the primary work orders according to the BOM table 3003 of the ERP system 3000. The displaying module 2310 still displays the primary work orders that are unsuccessfully uploaded to the ERP system 3000.

In other embodiments, the recording module 2340 may amend the error information of the primary work orders according to a customer amending table.

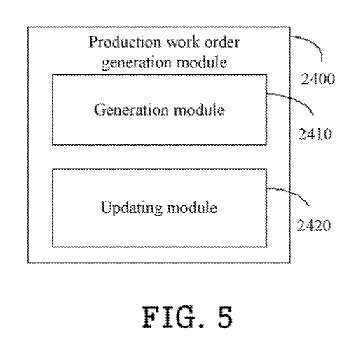

FIG. 5 is a schematic diagram of detailed functional modules of the production work order generation module 2400 of FIG. 1. In the exemplary embodiment, the production work order generation module 2400 includes a generation module 2410 and an updating module 2420.

The generation module 2410 downloads information of the check orders from the ERP system 3000 according to the downloading time table 2609, and generates the production work orders according to the downloaded information of the check orders. In the exemplary embodiment, the generation module 2410 obtains a time spot from the downloading time table 2609, and generates the production work orders according to the downloaded information of the check orders, and also records information of the production work orders in the production work order table 2605 and the production work order detail table 2606.

The updating module 2420 updates the downloading time table 2609. In the exemplary embodiment, the updating module 2420 updates the downloading time table 2609 according to the downloading time status of the generation module 2410.

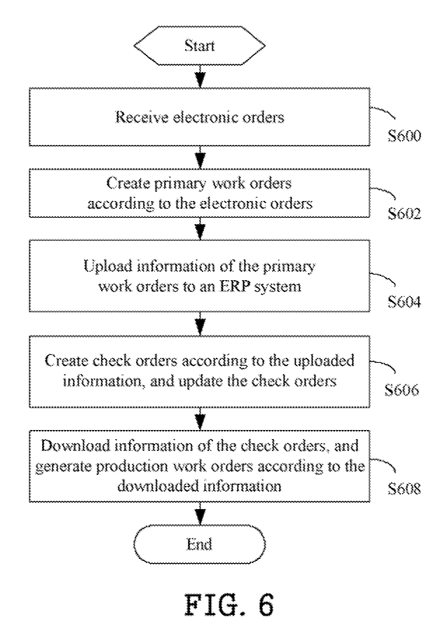

FIG. 6 is a flowchart of a method for converting electronic orders to work orders of an exemplary embodiment.

In step S600, the receiving module 2100 receives electronic orders.

In step S602, the primary work order creation module 2200 creates primary work orders according to the electronic orders.

In step S604, the uploading module 2300 uploads information of the primary work orders to the ERP system 3000.

In step S606, the ERP system 3000 creates check orders according to the uploaded information of the primary work orders, and updates the check orders.

In step S608, the production work order generation module 2400 downloads information of the check orders from the ERP system 3000, and generates production work orders according to the downloaded information of the check orders. Therefore, the electronic orders are successfully converted to the production work orders.

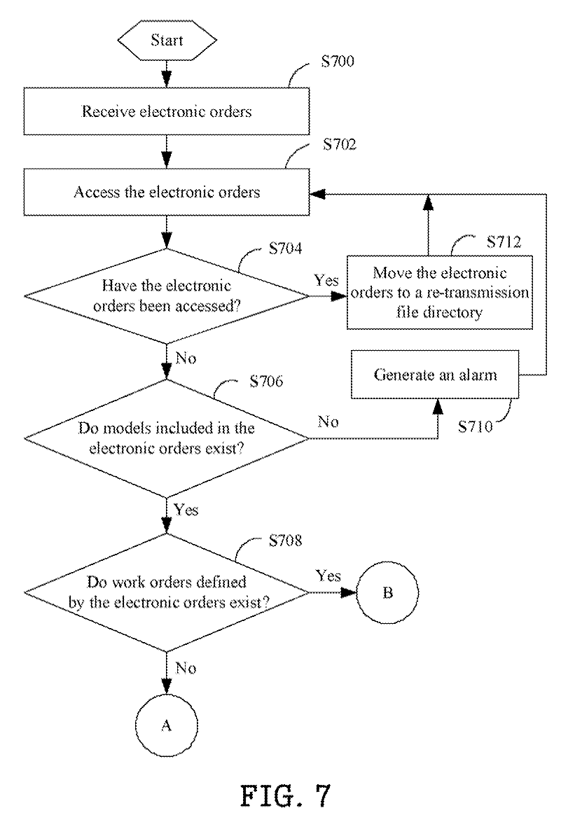

FIG. 7 is a detailed flowchart of part of the method for converting electronic orders to work orders of FIG. 6.

In step S700, the receiving module 2100 receives electronic orders from the B2B system 1000. In the exemplary embodiment, the electronic orders are RosettaNet-7B5 files. After receiving the electronic orders, the receiving module 2100 puts the electronic orders in the un-accessed file directory.

In step S702, the accessing module 2210 of the primary work order creation module 2200 accesses the electronic orders. In the exemplary embodiment, the accessing module 2210 accesses the RosettaNet-7B5 files from the un-accessed file directory.

In step S704, the name determination submodule 2221 of the order determination module 2220 determines whether the electronic orders have been accessed. In the exemplary embodiment, the name determination submodule 2221 determines whether the electronic orders has been accessed according to whether names of the electronic orders exist in the XML file name field of the normal work order table 2601. If the names of the electronic order exist in the XML file name field of the normal work order table 2601, the name determination submodule 2221 determines that the electronic orders have been accessed. If the names of the electronic orders do not exist in the XML file name field of the normal work order table 2601, the name determination submodule 2221 determines that the electronic orders have not been accessed.

If the electronic orders have been accessed, in step S712, the name determination submodule 2221 moves the electronic orders to the re-transmission file directory.

If the electronic orders have not been accessed, in step S706, the model determination submodule 2222 determines whether models included in the electronic orders exist in the model information table 2607.

If the models included in the electronic orders do not exist in the model information table 2607, in step S710, the model determination submodule 2222 generates an alarm. Then, going back to step S702, the accessing module 2210 goes on to access other electronic orders.

If the models included in the electronic orders exist in the model information table 2607, in step S708, the work order determination submodule 2223 determines whether work orders defined by the electronic orders exist in the normal work order table 2601. In the exemplary embodiment, the work order determination submodule 2223 determines whether work orders defined by the electronic orders exist in the normal work order table 2601 according to whether sale order number information, line number information, and ship set information of each work order defined by the electronic orders respectively exist in the sale order field, the line number field, and the ship set field of an entry of the normal work order table 2601.

If the sale order number information, the line number information, and the ship set information of each work order defined by the electronic orders do not respectively exist in the sale order field, the line number field, and the ship set field of one entry of the normal work order table 2601, the work order determination submodule 2223 determines that the work orders defined by the electronic orders do not exist in the normal work order table 2601. If the sale order number information, the line number information, and the ship set information of each work order defined by the electronic orders respectively exist in the sale order field, the line number field, and the ship set field of one entry of the normal work order table 2601, the work order determination submodule 2223 determines that the work orders defined by the electronic orders exist in the normal work order table 2601. In the following text, the work orders with the sale order, the line number, and the ship set information the same as that of the electronic orders are called original work orders.

If the work orders defined by the electronic orders do not exist in the normal work order table 2601, the flow goes to a node A.

If the work orders defined by the electronic orders exist in the normal work order table 2601, the flow goes to a node B.

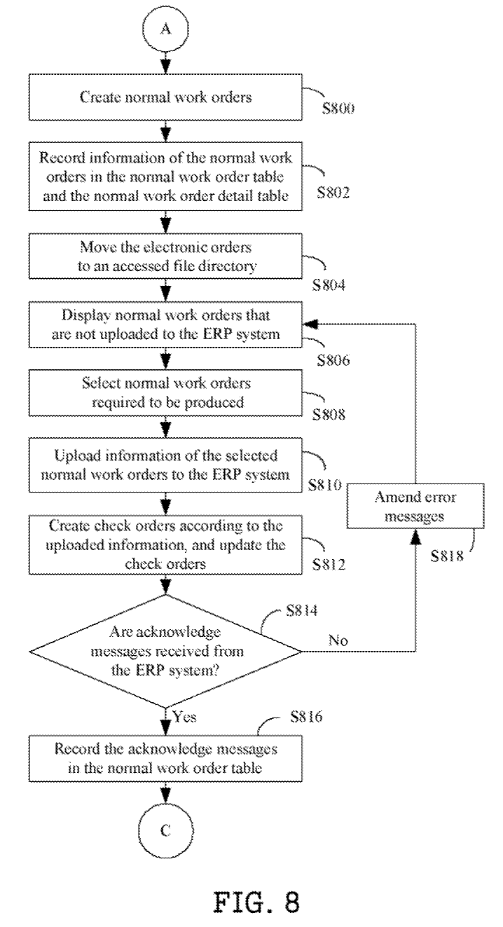

FIG. 8 is a detailed flowchart after the node A of FIG. 7.

If the work orders defined by the electronic orders do not exist in the normal work order table 2601, going to step S800 from the node A of FIG. 7, the creation module 2230 creates normal work orders.

In step S802, the creation module 2230 records information of the normal work orders in the normal work order table 2601 and the normal work order detail table 2602.

In step S804, the creation module 2230 moves the electronic orders to an accessed file directory.

In step S806, the displaying module 2310 displays primary work orders that are not uploaded to the ERP system 3000.

In step S808, the selection and uploading module 2320 selects normal work orders required to be produced.

In step S810, the selection and uploading module 2320 uploads information of the selected normal work orders to the ERP system 3000. In the exemplary embodiment, the selection and uploading module 2320 may automatically select the primary work orders required to be produced according to a list provided by customers, or select the primary work orders according to information input by operators or engineers.

In step S812, the ERP system 3000 creates check orders according to the uploaded information of the normal work orders, and updates the check orders. In the exemplary embodiment, content of the check orders is the same as that of the normal work orders. The check order creation module 3010 creates the check orders according to the uploaded information of the normal work orders. In this embodiment, the check orders may be saved in the saving module 3030. The checking module 3020 checks the check orders, and updates the check orders according to the BOM table 3003. In the exemplary embodiment, the checking module 3020 checks whether part numbers in each check order are listed in the BOM table 3003. If the part numbers in the check orders are listed in the BOM table 3003, the checking module 3020 transmits acknowledge messages to the SFC system 2000. If the part numbers in the check orders are not listed in the BOM table 3003, the checking module 3020 transmits error messages to the SFC system 2000. The checking module 3020 also supplements necessary information, such as necessary part numbers, for the check orders. Thus, the checking module 3020 successfully updates the check orders.

In step S814, the success determination module 2330 of the SFC system 2000 determines whether acknowledge messages are received from the ERP system 3000.

If the acknowledge messages are received from the ERP system 3000, indicating the information of the normal work orders are successfully uploaded to the ERP system 3000, in step S816, the recording module 2340 records the acknowledge messages in the return message field of the normal work order table 2601. Then, the flow goes to a node C.

If the acknowledge messages are not received from the ERP system 3000, indicating the information of the normal work orders are unsuccessfully uploaded to the ERP system 3000, in step S818, the recording module 2340 amends the error messages according to the BOM table 3003 of the ERP system 3000. The displaying module 2310 still displays the normal work orders that are unsuccessfully uploaded to the ERP system 3000.

In other embodiments, the recording module 2340 may amend the error messages of the normal work orders according to the customer amending table.

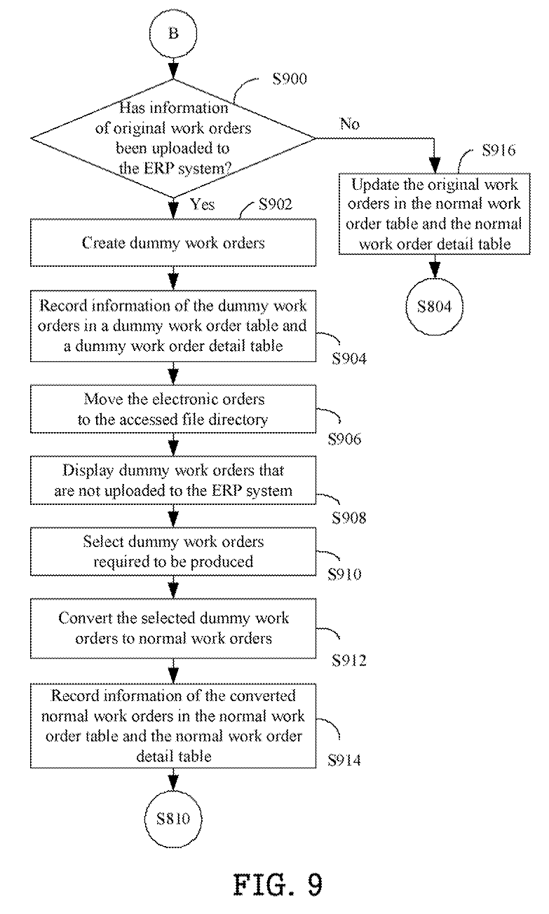

FIG. 9 is a detailed flowchart after the node B of FIG. 7.

If the work orders defined by the electronic orders exist in the normal work order table 2601, going to step S900 from the node B, the work order determination submodule 2223 further determines whether information of the original work orders has been uploaded to the ERP system 3000.

If the information of the original work orders has not been uploaded to the ERP system 3000, in step S916, the creation module 2230 updates the information of the original work orders in the normal work order table 2601 and the normal work order detail table 2602 according to the electronic orders. Then the flow goes back to step S804 of FIG. 8, the creation module 2230 moves the electronic orders to the accessed file directory.

If the information of the original work orders has been uploaded to the ERP system 3000, in step S902, the creation module 2230 creates dummy work orders.

In step S904, the creation module 2230 records information of the dummy work orders in the dummy work order table 2603 and the dummy work order detail table 2604.

In step S906, the creation module 2230 moves the electronic orders to the accessed file directory.

In step S908, the displaying module 2310 displays dummy work orders that are not uploaded to the ERP system 3000.

In step S910, the selection and uploading module 2320 selects dummy work orders required to be produced.

In step S912, the selection and uploading module 2320 converts the selected dummy work orders to normal work orders. In the exemplary embodiment, the difference between the dummy work orders and the converted normal work orders is that the work order numbers of the dummy work orders and the work order numbers of the converted normal work orders are respectively dummy work order numbers and normal work order numbers. The other information of the dummy work orders is the same that of the converted normal work orders. Then the selection and uploading module 2320 uploads the information of the converted normal work orders to the ERP system 3000.

In step S914, the recording and uploading module 2320 records information of the converted normal work orders in the normal work order table 2601 and the normal work order detail table 2602. Then going back to step S810 of FIG. 8, the selection and uploading module 2320 uploaded information of the converted normal work orders to the ERP system 3000.

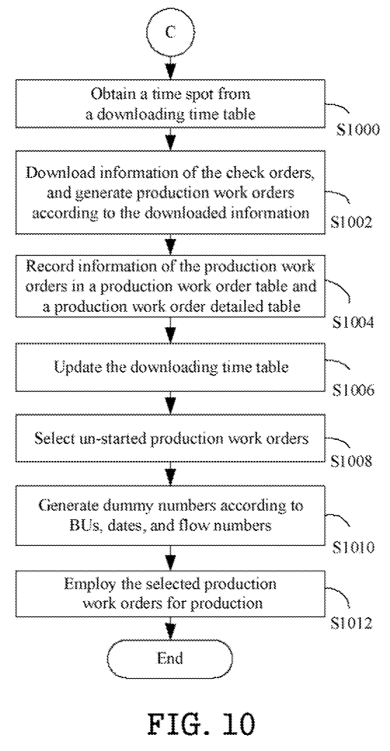

FIG. 10 is a detailed flowchart after a node C of FIG. 8.

Going to step S1000 from the node C of FIG. 8, the generation module 2410 obtains a time spot from the downloading time table 2609.

In step S1002, the generation module 2410 downloads information of the check orders according to BUs and the time spot, and generates the production work orders according the downloaded information of the check orders.

In step S1004, the generation module 2410 records information of the production work orders in the production work order table 2605 and the production work order detail table 2606.

In step S1006, the updating module 2420 updates the downloading time table 2609.

In step S1008, the production module 2500 selects un-started production work orders. In the exemplary embodiment, the production module 2500 selects un-started production work orders according to the start identifier field of the production work order table 2605.

In step S1010, the production module 2500 generates dummy numbers according to BUs, dates, and flow numbers.

In step S1012, the production module 2500 employs the selected production work orders for production.

Thus, the system for converting electronic orders to work orders successfully converts the electronic work orders to the production work orders via the SFC system 2000 and the ERP system 3000.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A system for converting electronic orders to work orders, comprising:
an enterprise resource planning (ERP) system; and
a shop floor control (SFC) system, comprising:
a receiving module, for receiving electronic orders;
a primary work order creation module, for creating primary work orders according to the electronic orders;
an uploading module, for uploading information of the primary work orders to the ERP system, wherein the ERP system creates check orders according to the uploaded information of the primary work orders, and updates the check orders; and
a production work order generation module, for downloading information of the check orders, and generating production work orders according to the downloaded information of the check orders.

2. The system as claimed in claim 1, wherein the electronic orders are RosettaNet-7B5 files, and the ERP system is a SAP system.

3. The system as claimed in claim 1, wherein the primary work order creation module comprises:
an accessing module, for accessing the electronic orders;
an order determination module, for identifying the electronic orders; and
a creation module, for creating the primary work orders according to the identified result of the order determination module.

4. The system as claimed in claim 3, wherein the order determination module comprises:
a name determination submodule, for determining whether the electronic orders have been accessed;
a model determination submodule, for determining whether models included in the electronic orders exist in a model information table; and
a work order determination submodule, for determining whether work orders defined by the electronic orders exist in a normal work order table, and determining whether information of original work orders have been uploaded to the ERP system when the work orders defined by the electronic orders exist in the normal work order table.

5. The system as claimed in claim 4, wherein the normal work order table comprises an extensible markup language (XML) file name field, a sale order number field, a line number field, and a ship set field; the name determination submodule is for determining whether the electronic orders have been accessed according to whether names of the electronic orders exist in the XML file name field of the normal work order table; the work order determination submodule is for determining whether work orders defined by the electronic orders exist in the normal work order table according to whether sale order number information, line number information, and ship set information of each work order defined by the electronic orders respectively exist in the sale order number field, the line number field, and the ship set field of an entry of the normal work order table.

6. The system as claimed in claim 3, wherein the primary work orders are normal work orders; the creation module is also for recording information of the normal work orders in a normal work order table and a normal work order detail table; the normal work order table comprises a work order number field, a sale order number field, a line number field, a ship set field, a model field, an order type field, a return message field, an XML file name field, a to country field, and a factory completed date field; the normal work order detail table comprises a work order number field, an option part number field, and a request quantity field.

7. The system as claimed in claim 3, wherein the primary work orders are dummy work orders; the creation module is also for recording information of the dummy work orders in a dummy work order table and a dummy work order detail table; the dummy work order table comprises a work order number field, a sale order number field, a line number field, a ship set field, a model field, an order type field, a return message field, an XML file name field, a to country field, and a factory completed date field; the dummy work order detail table comprises a work order number field, an option part number field, and a request quantity field.

8. The system as claimed in claim 1, wherein the uploading module comprises:
a displaying module, for displaying primary work orders that are not uploaded to the ERP system;
a selection and uploading module, for selecting primary work orders required to be produced, and uploading information of the selected primary work orders to the ERP system;
a success determination module, for determining whether acknowledge messages are received from the ERP system; and
a recording module, for recording the acknowledge messages in a normal work order table.

9. The system as claimed in claim 1, wherein the production work order generation module comprises:
a generation module, for obtaining a time spot from a downloading time table, downloading information of the check orders from the ERP system according to the time spot, and generating the production work orders according to the downloaded information of the check orders; and
a updating module, for updating the downloading time table.

10. The system as claimed in claim 9, wherein the generation module is also for recording information of the production work orders in a production work order table and a production work order detail table; the production work order table comprises a work order number field, a model field, a route identifier field, and a start identifier field; the production work order detail table comprises a work order number field, an option number field, and a request quantity field.

11. The system as claimed in claim 1, wherein the ERP system comprises:
a saving module, for saving a bill of material (BOM) table;
a check order creation module, for creating the check orders according to the uploaded information of the primary work orders, and saving the check orders in the saving module;
a checking module, for checking and updating the check orders according to the BOM table.

12. A method for converting electronic orders to work orders, comprising:
receiving electronic orders;
creating primary work orders according to the electronic orders;
uploading information of the primary work orders to an enterprise resource planning (ERP) system;
creating check orders according to the uploaded information of the primary work orders, and updating the check orders by the ERP system; and
downloading information of the check orders from the ERP system, and generating production work orders according to the downloaded information of the check orders.

13. The method as claimed in claim 12, wherein creating primary work orders according to the electronic orders comprises:
accessing the electronic orders;
determining whether the electronic orders have been accessed;
determining whether models included in the electronic orders exist in a model information table if the electronic orders have not been accessed;
determining whether work orders defined by the electronic orders exist in a normal work order table if the models included in electronic orders exist in the model information table; and
creating normal work orders if the work orders defined by the electronic orders do not exist in the normal work order table.

14. The method as claimed in claim 13, wherein determining whether the electronic orders have been accessed comprises determining whether names of the electronic orders exist in an extensible markup language (XML) file name field of the normal work order table; determining whether the work orders defined by the electronic orders exist in the normal work order table comprises determining whether sale order number information, line number information, and ship set information of each work order defined by the electronic orders respectively exist in a sale order number field, a line number field, and a ship set field of an entry of the normal work order table.

15. The method as claimed in claim 13, wherein creating primary work orders according to the electronic orders further comprises:
recording information of the normal work orders in the normal work order table and a normal work order detail table, wherein the normal work order table comprises a work order number field, a sale order number field, a line number field, a ship set field, a model field, an order type field, a return message field, an XML file name field, a to country field, and a factory completed date field; the normal work order detail table comprises a work order number field, an option part number field, and a request quantity field.

16. The method as claimed in claim 13, wherein creating primary work orders according to the electronic orders further comprises:
determining whether information of original work orders is uploaded to the ERP system if the work orders defined by the electronic orders exist in the normal work order table;
creating dummy work orders if the information of the original work orders is uploaded to the ERP system; and
recording information of the dummy work orders in a dummy work order table and a dummy work order detail table, wherein the dummy work order table comprises a work order number field, a sale order number field, a line number field, a ship set field, a model field, an order type field, a return message field, an XML file name field, a to country field, and a factory completed date field; the dummy work order detail table comprises a work order number field, an option part number field, and a request quantity field.

17. The method as claimed in claim 16, wherein creating primary work orders according to the electronic orders further comprises:
updating the original work orders in the normal work order table and the normal work order detail table if the information of the original work orders is not uploaded to the ERP system.

18. The method as claimed in claim 12, wherein uploading information of the primary work orders to the ERP system comprising:
displaying primary work orders that are not uploaded to the ERP system;
selecting primary work orders required to be produced:
uploading information of the selected primary work orders to the ERP system;
determining whether acknowledge messages are received from the ERP system; and
recording the acknowledge messages in a normal work order table if the acknowledge messages are received.

19. The method as claimed in claim 18, wherein the primary work orders are dummy work orders; uploading information of the primary work orders to the ERP system further comprises converting the dummy work orders to normal work orders; recording information of the converted normal work orders in the normal work order table and a normal work order detail table; and uploading information of the converted normal work orders to the ERP system.
